(19) United States
(12) Patent Application Publication
(10) Pub. No.: US 2026/0132009 A1
(43) Pub. Date: May 14, 2026

(54) SAFE SYSTEM FOR INDUSTRIAL VEHICLE

(71) Applicant: DOOSAN BOBCAT KOREA CO., LTD., Incheon (KR)

(72) Inventor: Yoonki JUNG, Incheon (KR)

(73) Assignee: DOOSAN BOBCAT KOREA CO., LTD., Incheon (KR)

(21) Appl. No.: 19/364,547

(22) Filed: Oct. 21, 2025

(30) Foreign Application Priority Data
Nov. 13, 2024 (KR) 10-2024-0161129

(51) Int. Cl. B66F 9/075; B66F 17/00

(52) U.S. Cl. CPC B66F 9/0755; B66F 17/003

(57) ABSTRACT

A safety system for an industrial vehicle is disclosed. A safety system for an industrial vehicle according to one aspect of the present invention may include a controller that controls the height lowering operation of the industrial vehicle's work implement; an obstacle detection sensor that detects an obstacle below the work implement; and a safety circuit connected to a sensor switch that receives a signal from the obstacle detection sensor, wherein the safety circuit switches the controller to an On or Off state based on the signal inputted from the sensor switch.

### CROSS-REFERENCE TO RELATED APPLICATION

This application claims the benefit of Korean Patent Application No. 10-2024-0161129, filed on Nov. 13, 2024 in the Korean Intellectual Property Office, the entire disclosure of which is incorporated herein by reference.

### TECHNICAL FIELD

Embodiments of the present disclosure relate to a safety system for an industrial vehicle, and more specifically, to a safety system for an industrial vehicle that detects an obstacle below the work implement and applies or limits a lowering operation of the work implement.

### BACKGROUND

In an industrial vehicle context, various equipment is used for order picking. For example, conveyors, stackers, and forklifts exist, among which there is the order picker.

An order picker is a type of forklift where not only the forks but also the driver's cab can be vertically raised. It's a compact forklift capable of both vertical and horizontal movement, making it the most used order-picking equipment in recent logistics operations. Typically, order pickers use a support structure called a pallet to transport goods. The pallet is lifted by the forks, and the structure connecting the order picker's mast and the forks is called the carriage.

The work implement of the order picker, such as the carriage, is attached to the mast to support the forks, providing stability when lifting or lowering goods. The order picker's forks support and transport the weight of the pallet and the goods.

Among these, the man-up order picker is a type where the operator rides directly on the work implement to operate it. This setup makes it difficult to check the area beneath the work implement. It's especially challenging for the operator to detect people or other obstacles below when the work implement is at the back, or when goods are loaded on the forks.

While cameras or mirrors can be used to check the area below, these tools require the operator's active attention during work, which can make accurate obstacle detection difficult. Therefore, safe operation can be promoted by using a safety circuit with sensors to detect obstacles, such as people or animals, in the descending range when the work implement is lowering.

### SUMMARY

A side of the disclosed invention aims to provide a safety system for an industrial vehicle that promotes safe operation by detecting obstacles, such as people or animals, in the lowering range using a safety circuit with a sensor when the work implement lowers.

A safety system for an industrial vehicle according to one side of the present invention may include a controller that controls the lowering operation of the industrial vehicle's work implement, an obstacle detection sensor that detects obstacles beneath the work implement, and a safety circuit that connects to a sensor switch receiving a signal from the obstacle detection sensor to switch the controller between an On and Off state based on the signal from the sensor switch.

The sensor switch, according to one side of the present invention, may input an Off signal to the safety circuit when an obstacle is detected through the obstacle detection sensor. The controller, according to one side of the present invention, may default process the Off signal inputted to the safety circuit from the sensor switch when the work implement's height reaches a pre-set safe height.

The safety circuit, according to one side of the present invention, may include a work implement switch that inputs an On signal to the safety circuit when the work implement's height reaches a pre-set safe height. The controller can process the signal inputted to the safety circuit from the work implement switch as a higher-priority command than the signal inputted to the safety circuit from the sensor switch.

The safety circuit, according to one side of the present invention, may have the sensor switch and the work implement switch connected in parallel. The sensor switch can perform real-time obstacle detection to generate an Off signal and then input an On signal to the safety circuit when an obstacle is no longer detected.

The controller, according to one side of the present invention, can determine the operator's control intention. If the safety circuit is in the Off state, the controller can permit the lowering operation of the work implement when a lowering action is identified as an intentional operation. The controller, according to one side of the present invention, can determine that the operator has intentionally controlled the Lift Lever if input for lowering the height is detected through the lift lever for a certain period while an Off signal is inputted to the safety circuit from the sensor switch and the industrial vehicle's lift lever is released.

The safety system for an industrial vehicle, according to one side of the present invention, may include a warning device, including at least one of a display and a buzzer, to provide warning information to the operator when an obstacle is detected. The controller, according to one side of the present invention, can activate the warning device when an Off signal is inputted to the safety circuit and can stop the operation of the warning device when the safety circuit switches from the Off state to the On state.

According to one side of the disclosed invention, the controller can assist with safe vehicle operation by detecting people and obstacles in the vehicle's blind spots, which are easily missed by the operator, using the obstacle detection sensor, and then controlling the work implement drive to block the lowering operation.

Furthermore, according to one side of the disclosed invention, by identifying an operator's intentional lift lever manipulation to place goods at a high location, the controller can selectively permit the work implement's lowering operation, even if an obstacle is detected, to efficiently promote safety and assist the operator's work.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a schematic diagram showing the configuration of an industrial vehicle;

FIG. 2 are schematic diagrams showing the configuration of a safety system for an industrial vehicle in accordance with one embodiment;

FIG. 3 are schematic diagrams showing the configuration of a safety system for an industrial vehicle in accordance with another embodiment;

FIG. 4 is a diagram showing the operation flow of a controller in accordance with one embodiment; and

FIG. 5 is a diagram showing a safety height in accordance with one embodiment.

### DETAILED DESCRIPTION

Throughout the specification, identical reference numerals refer to identical components. This specification does not describe every element of the embodiments, and common or overlapping content between embodiments is omitted. The terms ‘part, module, member, block’ as used in the specification can be implemented in software or hardware, and depending on the embodiments, it is possible for a plurality of ‘parts, modules, members, blocks’ to be implemented as a single component, or for a single ‘part, module, member, block’ to include a plurality of components.

When a part is said to be ‘connected’ to another part, this includes not only cases where they are directly connected, but also cases where they are indirectly connected, and indirect connection includes being connected through a wireless communication network.

Furthermore, when a part is said to ‘comprise’ another component, this means it may include other components unless there is a specific statement to the contrary.

When a member is said to be ‘on’ another member, this includes not only cases where the member is in contact with the other member, but also cases where there is another member between the two.

Terms such as ‘first’, ‘second’, etc., are used to distinguish one component from another, and the components are not limited by the terms used. A singular expression includes a plural expression unless the context clearly dictates an exception.

In each step, the identification numbers are used for convenience of explanation and do not describe the order of the steps. The steps can be performed in a different order from the one specified unless the context clearly states a specific order.

Hereinafter, the operational principles and embodiments of the disclosed invention will be described with reference to the attached drawings.

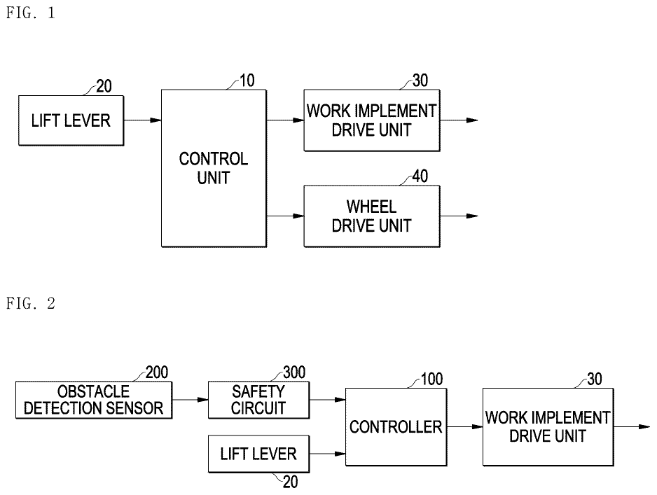

FIG. 1 is a schematic diagram showing the configuration of an industrial vehicle;

As shown in FIG. 1, the industrial vehicle (1) may include a control unit (10) that controls the overall operation of the vehicle, a Lift Lever (20) that inputs a signal regarding the operator's manipulation of the work implement's height to the control unit (10), a work implement drive unit (30) that drives the work implement according to the control signal from the control unit (10), and a wheel drive unit (40) that drives the wheels for the driving operation of the industrial vehicle (1) according to the control signal from the control unit (10).

Although not shown, the industrial vehicle (1) also includes a vehicle body with a cab for the driver and a display device to show information. The wheel drive unit (40) may include front wheels, rear wheels, a drive motor, and a drive motor control module. In addition, conventional technology components (e.g., accelerator pedal, brake pedal, steering wheel, lamps, speakers, etc.) for controlling the driving of the industrial vehicle (1) and the functions inside the vehicle are preferably provided inside and outside the cab.

At this time, the drive motor and the drive motor control module may be located inside the lower part of the cab, between the front and rear wheels. The drive motor control module can drive the drive motor in a first or a second rotational direction to perform a forward motion by the first rotational direction of the front and rear wheels, or a reverse motion by the second rotational direction.

On the other hand, the drive motor control module can generate a motor current to drive the drive motor in the first or a second rotational direction and apply it to the drive motor. For example, the drive motor control module may include an H-Bridge circuit composed of multiple power switching elements to drive the drive motor in the first or a second rotational direction.

Meanwhile, the work implement is provided at the front of the vehicle body and can perform tasks such as unloading, transporting, and loading cargo (A) according to the operator's manipulation. For example, the work implement may include a carriage that can be raised upwards or lowered downwards along a mast rail, and a pair of forks (31) connected to the carriage. It can be operated in the upward or downward direction by the work implement drive unit (30).

For this purpose, the work implement drive unit (30) may include a directional control valve that operates the work implement in the upward or downward direction to control its height. Specifically, the directional control valve is provided as a hydraulic block equipped with an upward valve and a downward valve, and can control the opening and closing of the flow paths of the respective upward and downward valves for the lifting of the work implement.

Specifically, the work implement drive unit (30) can set the work implement's operating mode based on its raising or lowering. Here, the work implement drive unit (30), based on the output of the Lift Lever (20) from the operator's manipulation, can set both the raising and lowering operations of the work implement, as well as a lift-stop mode that restricts the raising and lowering, thereby controlling the opening and closing of the flow paths of the upward and downward valves, respectively.

Meanwhile, the Lift Lever (20) can output a lift-selection signal to select the raising, lowering, or stopping of the forks based on its operating state and input it to the control unit (10). Based on this, the control unit (10) can control the work implement through the work implement drive unit (30).

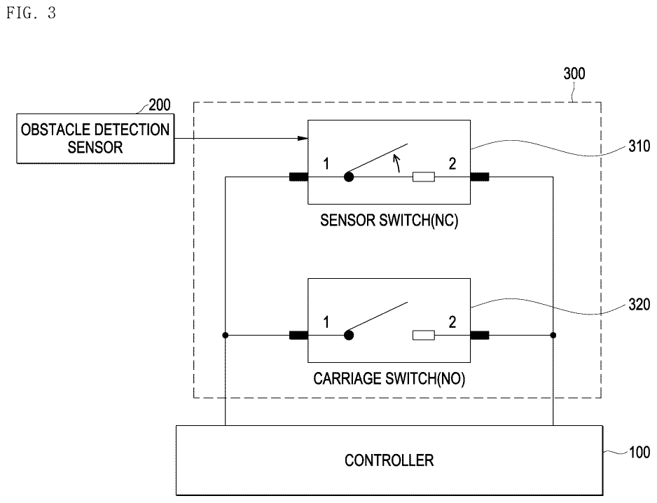

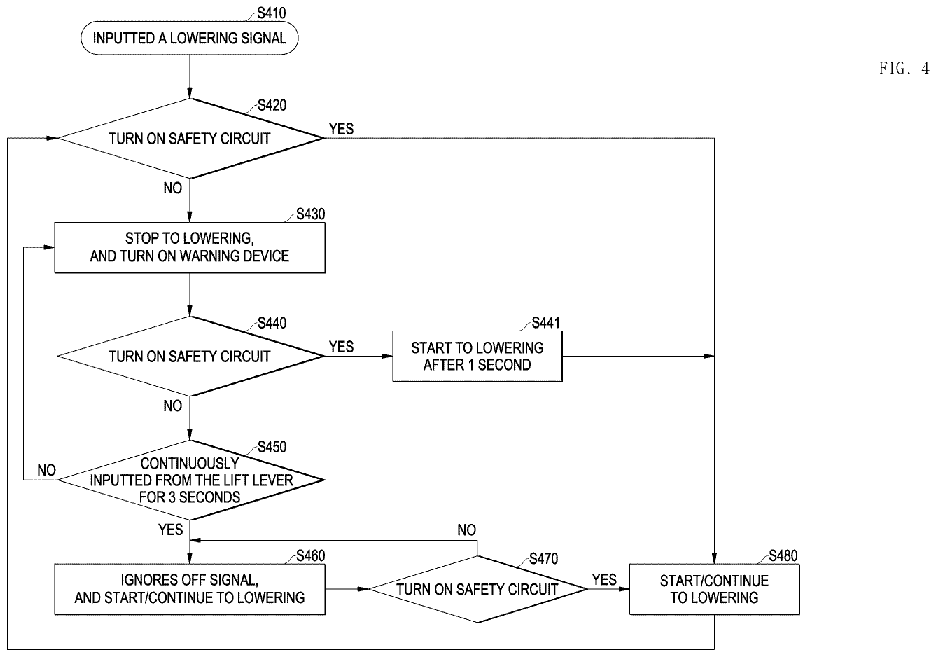

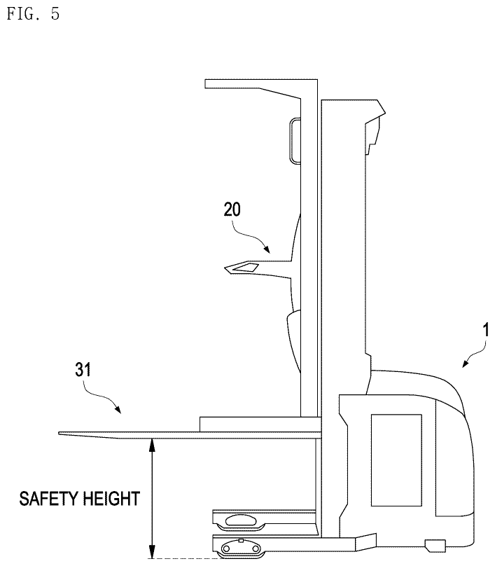

FIG. 2 are schematic diagrams showing the configuration of a safety system for an industrial vehicle in accordance with one embodiment, FIG. 3 are schematic diagrams showing the configuration of a safety system for an industrial vehicle in accordance with another embodiment, FIG. 4 is a diagram showing the operation flow of a controller in accordance with one embodiment, and FIG. 5 is a diagram showing a safety height in accordance with one embodiment.

As shown in FIGS. 2 and 3, a safety system for an industrial vehicle according to one aspect of the present invention may include a controller (100), an obstacle detection sensor (200), and a safety circuit (300).

Specifically, as shown in FIG. 2, the controller (100) controls the height lowering operation of the industrial vehicle (1)'s work implement and can acquire input regarding the operator's work implement height control via the Lift Lever (20). As an example, the industrial vehicle can be a man-up order picker, in which case the work implement may correspond to a configuration including a carriage and forks (31), but is not limited thereto.

Although not shown, the controller (100) can be the control unit (10), be included in the control unit (10), or be implemented as a separate component from the control unit (10). The controller (100) may include a processor, memory, and communication unit. For example, the memory can store various programs and data required for the operation of the controller (100), and the communication unit can perform communication with external devices. In particular, the communication unit can perform communication according to various communication standards by including various communication chips such as a Wi-Fi chip, Bluetooth chip, wireless communication chip, NFC chip, low-power Bluetooth chip (BLE chip), etc. The processor can control the overall operation of the controller (100) using the various programs stored in the memory.

The obstacle detection sensor (200) is a sensor that detects, senses, or measures an obstacle within a certain distance, and can be implemented with a laser sensor, LiDAR sensor, ultrasonic sensor, camera, etc., but is not limited thereto.

The safety circuit (300) is connected to a sensor switch (310) that receives a signal from the obstacle detection sensor (200). It can switch the controller (100) to an On or Off state based on the signal inputted from the sensor switch (310).

Specifically, the sensor switch (310) can input an Off signal to the safety circuit (300) when an obstacle is detected via the obstacle detection sensor (300). Accordingly, the safety circuit (300) enters the Off state, and the controller (100) determines that an obstacle exists. It can recognize the signal from the sensor switch (310) as a higher-priority command and interrupt the work implement's height lowering operation, even if input is received from the operator via the Lift Lever (20).

Meanwhile, the controller (100) can be implemented in software or hardware to default process the Off signal inputted to the safety circuit (300) from the sensor switch (310) when the work implement's height reaches a pre-set safety height.

Referring to FIG. 5, the safety height is the height from the ground to the bottom surface of the work implement. Referring to FIG. 5, the safety height can be a pre-set certain height up to the forks (31) provided on the work implement.

As an embodiment for implementing this in hardware, the safety circuit (300) may include a carriage switch (320), as shown in FIG. 3. The sensor switch (310) and the carriage switch (320) that make up the safety circuit (320) can be connected in parallel. Specifically, the carriage switch (320) can input an On signal to the safety circuit (300) when the work implement's height reaches the pre-set safety height or is separated from the ground by more than the safety height. At this time, the controller (100) can process the signal inputted to the safety circuit (300) from the carriage switch (320) as a higher-priority command than the signal inputted to the safety circuit (300) from the sensor switch (310).

Meanwhile, the sensor switch (310) performs real-time obstacle detection via the obstacle detection sensor (200). After generating an Off signal, if no obstacle is detected, it can input an On signal to the safety circuit (300). The controller (100) then determines that the obstacle has been removed and can permit the height lowering operation of the work implement that was previously stopped.

Furthermore, the controller (100) can determine the operator's control intention. If the safety circuit (300) is in the Off state, it can permit the work implement's height lowering operation if a lowering action from intentional manipulation is identified. Specifically, the controller (100) can determine that the operator has intentionally controlled the Lift Lever (20) and ignore the Off signal if, after an Off signal is inputted to the safety circuit from the sensor switch (310), and with the industrial vehicle's Lift Lever (20) released, input for lowering the height via the Lift Lever (20) is continuously detected for a certain period of time. In other words, if the operator's input to the Lift Lever (20) is maintained for a certain period of time even after the initial input to the Lift Lever (20) has been released, it can be determined that the operator is intentionally controlling the Lift Lever (20) to place cargo at a high location.

For example, if during the work implement's height lowering operation, an Off signal is inputted to the safety circuit from the sensor switch (310), causing the work implement to stop, and then the operator's input for the work implement's height lowering is continuously inputted via the Lift Lever (20) for 3 seconds immediately after the stop, the controller (100) can switch to an override mode to ignore the Off signal and permit the work implement's height control via the Lift Lever (20).

Although not shown, a safety system for an industrial vehicle (1) according to one aspect of the present invention may include a warning device that includes at least one of a display and a buzzer to provide warning information to the operator when an obstacle is detected.

At this time, the display can be either a navigation device or a display device provided in the industrial vehicle (1). It can also be at least one of a display separately provided on the work implement, a display provided in the workspace, and an electronic device including a display held by the operator, but is not limited thereto.

Accordingly, the controller (100) can operate the warning device when an Off signal is inputted to the safety circuit (300) and can stop the operation of the warning device when the safety circuit (300) switches from the Off state to the On state. For example, if an obstacle is detected during the work implement's height lowering operation, causing the implement to stop, the controller (100) can display an obstacle detection error on the display and operate the buzzer.

Therefore, to describe the overall operation of the controller (100) in detail, referring to FIG. 4, when a lowering signal for the work implement is inputted via the Lift Lever (20) (S410), the controller (100) can determine whether the safety circuit (300) is in the On state (S420).

At this time, if the safety circuit (300) is in the On state, the controller (100) permits the work implement's height lowering operation, and the operation of the work implement can start or continue (S480).

Conversely, if the safety circuit (300) is in the Off state, the controller (100) stops the work implement's height lowering operation and can activate the warning device (S430).

Afterward, the controller (100) can monitor in real-time whether the safety circuit (300) is in the On state (S440). At this time, if the obstacle is removed and the safety circuit (300) switches to the On state, the controller (100) permits the work implement's height lowering operation 1 second after the safety circuit (300) switches to the On state (S441), and the operation of the work implement can start (S480).

On the other hand, if the safety circuit (300) is in the Off state, and if a signal instructing the work implement's height lowering operation by the operator is continuously inputted from the Lift Lever (20) for 3 seconds while the input to the Lift Lever (20) is in a released state immediately after the work implement's height lowering operation has been stopped (S450), the controller (100) switches to a mode that ignores the Off signal (override mode) and can start or continue the work implement's height lowering operation (S460).

At this time, the controller (100) can monitor in real-time whether the safety circuit (300) is in the On state (S470). If the safety circuit (300) is in the On state, the controller (100) permits the work implement's height lowering operation, and the operation of the work implement can start or continue (S480). In addition, since it is in override mode, the operation of the work implement can also start or continue (S480) even if the safety circuit (300) is in the Off state.

Furthermore, even when the operation of the work implement has started or is continuing (S480), the controller (100) can monitor in real-time whether the safety circuit (300) is in the On state (S420).

The aforementioned specification can be implemented as a computer-readable code on a program-recorded medium. A computer-readable medium can include all kinds of recording devices that store data readable by a computer system. Examples of computer-readable media include HDD (Hard Disk Drive), SSD (Solid State Disk), SDD (Silicon Disk Drive), ROM, RAM, CD-ROM, magnetic tape, floppy disk, optical data storage device, etc., and can also include implementations in the form of a carrier wave (e.g., transmission over the Internet). Therefore, the detailed description above should not be construed as being restrictive in all aspects but as being illustrative. The scope of this specification should be determined by a reasonable interpretation of the appended claims, and all modifications within the equivalent scope of this specification are included within the scope of this specification.

Also, although the embodiments have been described focusing on the examples, this is merely an example and does not limit this specification. It will be apparent to a person of ordinary skill in the art to which this specification pertains that various modifications and applications not exemplified above are possible without departing from the essential characteristics of the embodiments. For example, each component shown specifically in the embodiments can be modified and implemented. And the differences related to such modifications and applications should be interpreted as being included in the scope of this specification as defined by the appended claims.

What is claimed is:

1. A safety system comprising:
a controller for controlling a height lowering operation of a work implement of an industrial vehicle;
an obstacle detection sensor for detecting an obstacle below the work implement; and
a safety circuit connected to a sensor switch for receiving a signal from the obstacle detection sensor, wherein the safety circuit switches the controller to an On or Off state based on the signal inputted from the sensor switch.

2. The safety system of claim 1, wherein the sensor switch inputs an Off signal to the safety circuit when an obstacle is detected through the obstacle detection sensor.

3. The safety system of claim 1, wherein the controller defaults to processing an Off signal inputted to the safety circuit from the sensor switch when the work implement's height reaches a pre-set safe height.

4. The safety system of claim 1, wherein the safety circuit comprising:
a carriage switch that inputs an On signal to the safety circuit when the work implement's height reaches a pre-set safe height,
wherein the controller is configured to:
processes the signal inputted to the safety circuit from the carriage switch as a higher-priority command than the signal inputted to the safety circuit from the sensor switch.

5. The safety system of claim 4, wherein the sensor switch and the carriage switch are connected in parallel in the safety circuit.

6. The safety system of claim 1, wherein the sensor switch performs real-time obstacle detection to generate an Off signal and then inputs an On signal to the safety circuit when an obstacle is no longer detected.

7. The safety system of claim 1, wherein the controller determines the operator's intention to control the work implement and, if the safety circuit is in the Off state, permits the height lowering operation of the work implement when a lowering action from intentional manipulation is identified.

8. The safety system of claim 7, wherein the controller determines that the operator has intentionally controlled the Lift Lever if input for lowering the height via the Lift Lever is detected for a certain period of time after an Off signal is inputted to the safety circuit from the sensor switch.

9. The safety system of claim 7, wherein The safety system comprising a warning device that includes at least one of a display and a buzzer, to provide warning information to the operator when an obstacle is detected.

10. The safety system of claim 9, wherein the controller activates the warning device when an Off signal is inputted to the safety circuit and stops the operation of the warning device when the safety circuit switches from the Off state to the On state.
